(19) United States
(12) Patent Application Publication
(10) Pub. No.: US 2011/0261255 A1
(43) Pub. Date: Oct. 27, 2011

(54) VIDEO DISPLAY CONTROL DEVICE, VIDEO DISPLAY DEVICE, AND RECORDING MEDIUM HAVING VIDEO DISPLAY PROGRAM RECORDED THEREON

(75) Inventor: Hiroshi Nagata, Isehara (JP)

(73) Assignee: PIONEER CORPORATION, Kawasaki-shi (JP)

(21) Appl. No.: 13/132,384

(22) PCT Filed: Dec. 5, 2008
(86) PCT No.: PCT/JP2008/072145

§ 371 Date: Jun. 22, 2011

(51) Int. Cl. H04N 7/01

(52) U.S. Cl. 348/441; 348/E07.003

(57) ABSTRACT

A video display device includes: a valid area judging unit; a scene change detector; a video conversion processor; and a video display unit. The valid area judging unit recognizes an input video signal and judges an aspect ratio of a valid area of the input video signal. The scene change detector detects a moment when a series of highly related videos in terms of time are switched. The video conversion processor converts the input video signal based on the aspect ratio of the valid area judged by the valid area judging unit relative to the input video signal and scene change information detected by the scene change detector, and outputs the converted video signal to the video display unit. The video display unit conducts a control for displaying an output video signal outputted from the video conversion processor on a display area.

### TECHNICAL FIELD

The present invention relates to a video display controller, video display device, video display method, video display program and recording medium having the program recorded thereon

### BACKGROUND ART

Digitalization of broadcasting has been promoted worldwide, in which an aspect ratio in most digital broadcasting is 16:9. However, since an aspect ratio in typical broadcasting is 4:3 or an aspect ratio of a broadcasting equipment is 4:3, an aspect ratio of a practical valid area is often 4:3 while an aspect ratio of a video signal to be broadcasted is 16:9. Thus, a video signal representing a valid area with an aspect ratio of 16:9 and a video signal representing a valid area with an aspect ratio of 4:3 are temporally switched. Accordingly, in most current broadcasting, in order to transfer a video content with an aspect ratio of 4:3 to a broadcasting signal with an aspect ratio of 16:9, the aspect ratio of 4:3 is made to be an aspect ratio of 16:9 by adding black or grey non-image portions or images designed with pictures on both sides of the valid area with the aspect ratio of 4:3.

On the other hand, in PDP (Plasma Display Panel) or CRT (Cathode Ray Tube), when displays on both sides of a screen are kept black for a long time, deterioration in phosphors occurs only on a central part of the screen, not on the both sides thereof to cause deterioration in uniform brightness over the screen, or users feel the screen wasted because a size of the screen is reduced by not displaying an image entirely over the screen. In order to solve these problems, a television set has a function displaying a valid area over an entire screen by expanding a video screen in a horizontal direction by a manual operation using a remote controller and the like, or a television set has a function detecting an input of a video signal representing a valid area with an aspect ratio of 4:3 and displaying the valid area over an entire screen by automatically expanding a video screen in a horizontal direction (see, for instance, Patent Document 1).

In Patent Document 1, when the television set receives a so-called false 16:9 program, which is provided by adding black-belt-like side panels to left and right sides of a video with an aspect ratio of 4:3, and when an image receiver has an aspect ratio of 16:9, the television set cuts the side panels of the false 16:9 video signal and horizontally expands the video signal to output the video signal as a video signal having an aspect ratio of 4:3.

Patent Document 1: JP-A-2001-8128

### DISCLOSURE OF THE INVENTION

### Problems to be Solved by the Invention

However, as disclosed in Patent Document 1, when the aspect ratio of the video is automatically converted for display in the receiver, an aspect ratio of each of a series of highly related videos may be abruptly changed, which may be unnatural or annoying for users.

An object of the invention is to provide a video display controller preventing seizure in a display area and displaying videos naturally and suitably, a video display device, a method thereof, a program thereof and a recording medium having the program recorded thereon.

### Means for Solving the Problems

A video display controller according to an aspect of the invention processes an input video signal to display the input video signal on a display area with a predetermined aspect ratio, and the video display controller includes: a valid area judging unit that judges an aspect ratio of a valid area represented by the input video signal; a scene change detector that detects a scene change in the input video signal; and a video conversion processor that converts the input video signal by an expansion processing or a non-expansion processing of the valid area in accordance with a change of the aspect ratio of the valid area in the input video signal, and displays the converted input video signal as an output video signal on the display area, in which the video conversion processor synchronizes at least one of the expansion processing and the non-expansion processing with the detected scene change.

A video display device according to another aspect of the invention includes the above video display controller and a video display unit that displays the output video signal generated in the video display controller.

A video display method according to still another aspect of the invention includes processing an input video signal and displaying the input video signal on a display area with a predetermined aspect ratio, by a computer, the method by the computer including: judging unit that judges an aspect ratio of a valid area represented by the input video signal; detecting a scene change in the input video signal; converting the input video signal by an expansion processing or a non-expansion processing of the valid area in accordance with a change of the aspect ratio of the valid area in the input video signal, displaying the converted input video signal as an output video signal on the display area, and synchronizing at least one of the expansion processing and the non-expansion processing with the detected scene change.

A video display program according to a further aspect of the invention operates a computer to execute the above video display method.

A recording medium according to a still further aspect of the invention records the above video display program in a manner readable by a computer.

### BRIEF DESCRIPTION OF DRAWINGS

FIG. 1 is a block diagram schematically showing an arrangement of a video display device according to a first exemplary embodiment of the invention.

FIG. 2 is an illustration showing a method for detecting a valid area of a video displayed on the video display device according to the first exemplary embodiment.

FIG. 3 is a graph showing a distribution in brightness of the videos displayed on the video display device according to the first exemplary embodiment.

FIG. 4 is a graph showing a distribution in brightness of the videos displayed on the video display device according to the first exemplary embodiment.

FIG. 5 is an illustration showing a flow of the videos displayed on the video display device according to the first exemplary embodiment.

FIG. 6 is an illustration showing a flow of the videos displayed on the video display device according to a second exemplary embodiment of the invention.

### EXPLANATION OF CODES

10 video display device
100 video display controller serving as a computer
110 valid area judging unit
120 scene change detector
130, 131 video conversion processor
200 video display unit

### BEST MODE FOR CARRYING OUT THE INVENTION

### FIRST EXEMPLARY EMBODIMENT

A first exemplary embodiment of the invention will be described below with reference to the attached drawings.

In the first exemplary embodiment, a video display device displaying a video on a valid area with an aspect ratio of 16:9 is exemplarily explained.

Arrangement of Video Display Device

Firstly, an arrangement of the video display device will be described.

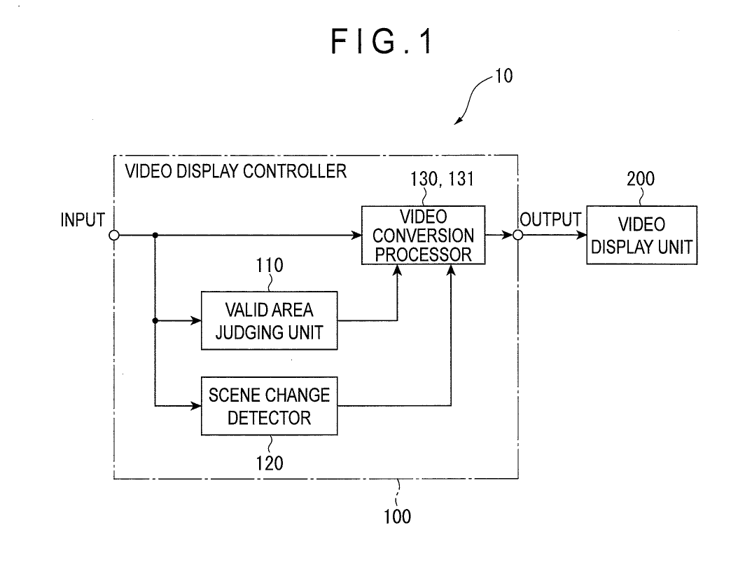

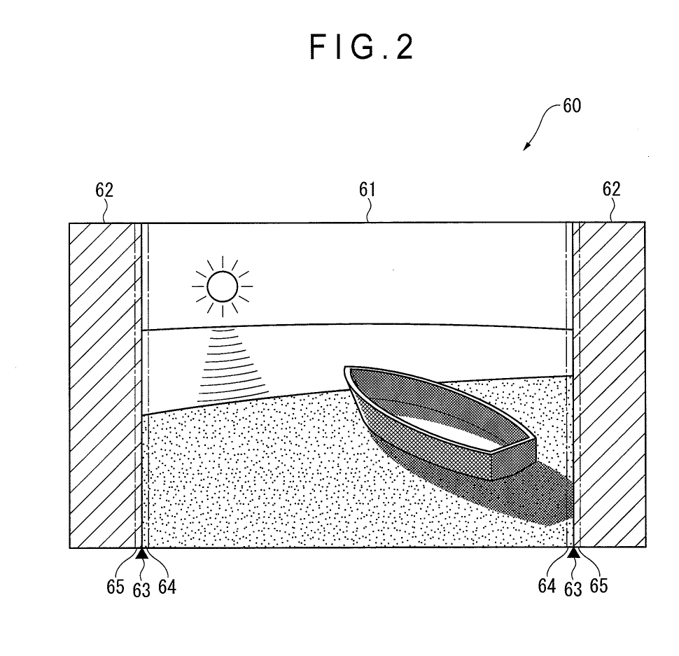

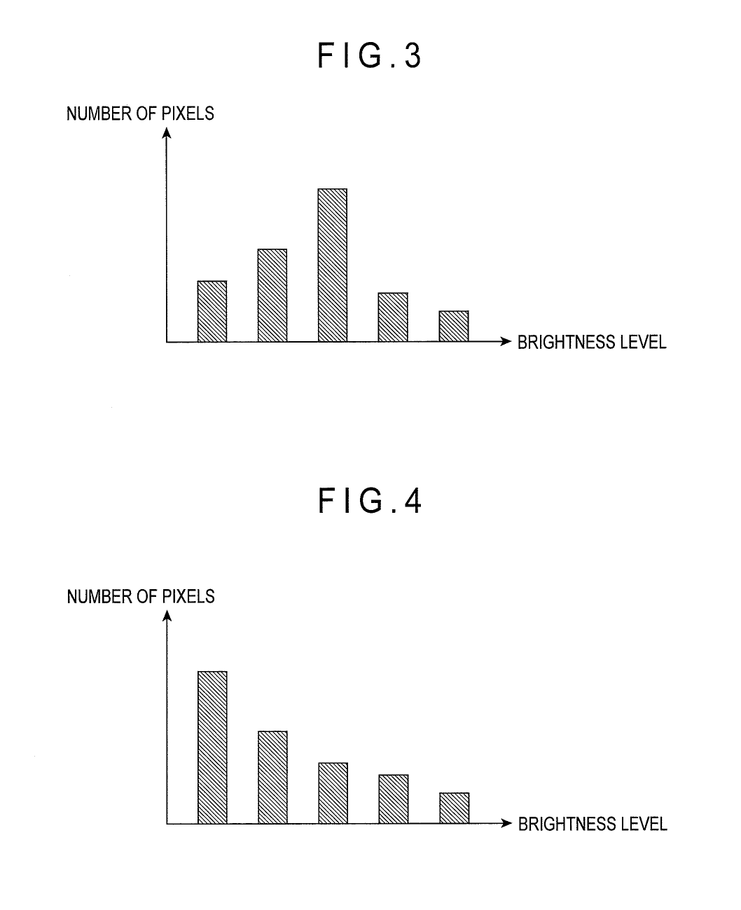

FIG. 1 is a block diagram schematically showing an arrangement of the video display device according to the first exemplary embodiment of the invention. FIG. 2 is an illustration showing a method for detecting a valid area of a video displayed on the video display device according to the first exemplary embodiment. FIG. 3 is a graph showing a distribution in brightness of the videos displayed on the video display device according to the first exemplary embodiment. FIG. 4 is a graph showing a distribution in brightness of the videos displayed on the video display device according to the first exemplary embodiment.

As shown in FIG. 1, the video display device converts an input video signal to a video corresponding to a display area with an aspect ratio of 16:9 of a video display unit 200 and displays the video. The video display device includes a video display controller 100 as a computer and the video display unit 200. Moreover, the video display device may include, for instance, a storage, in which data such as an aspect ratio of the video display unit 200 is recordable in a readable manner, or may include a data acquiring unit. The data acquiring unit may be: a tuner that receives a broadcast wave through, for instance, an antenna and acquires a video signal from the broadcast wave; a communication unit that acquires a video signal transmitted through communication lines, for instance, on a network; or a drive device capable of reading a video signal recorded in a recording medium such as various optical discs (e.g., CD, DVD and MD), magnetic optical discs and magnetic discs.

The video display controller 100 processes an input video signal to output the input video signal to the video display unit 200 as an output video signal. The video display controller 100 includes a valid area judging unit 110, a scene change detector 120, and a video conversion processor 130.

The valid area judging unit 110 recognizes the input video signal and judges an aspect ratio of a valid area of the input video signal. For instance, FIG. 2 shows a video 60 having a valid area with an aspect ratio of 4:3 in a display area with an aspect ratio of 16:9. The video 60 is provided with a valid area 61 with an aspect ratio of 4:3 and black-belt-like non-image portions 62 provided on the left and right of the valid area 61. With respect to a boundary 63 between the valid area 61 and each of the non-image portions 62 and predetermined areas 64 and 65 around the boundary 63, the valid area judging unit 110 calculates a difference absolute value between a brightness signal level of a first pixel of the input video signal and a brightness signal level of one of pixels horizontally adjacent to the first pixel, accumulates the difference absolute value in a vertical direction of the input video signal, calculates a peak value and an average value of the accumulated results, and judges that the video with the aspect ratio of 16:9 contains the valid area 61 with the aspect ratio of 4:3 and the non-image portions 62 on the left and right of the valid area 61 when a difference absolute value between the peak value and the average value is a reference value or more and a position of a pixel in which the peak value appears is expected to be on the boundary 63 between the valid area 61 and the non-image portions 62. Further, this processing is accumulated in terms of time as a time constant processing to provide a judgment after a predetermined time as a final judgment, so that an erroneous judgment is avoidable. A judgment method of a valid area is not limited to this. For instance, a judgment method based on a larger motion amount of the valid area 61 with the aspect ratio of 4:3 in the video with the aspect ratio of 16:9 than motion amounts of the non-image portions 62 on the left and right of the valid area 61 may be employed.

The scene change detector 120 detects a moment when a series of highly related videos in terms of time are switched. Specifically, there are a method for detecting a switching moment based on a rapid change of APL (Average Picture Level) in terms of time over an entire screen, and a method for judging as a scene change a detection of a rapid change of histogram of a brightness signal or an RGB signal. For instance, FIG. 3 shows a distribution in brightness of a video A displayed on a display area. FIG. 4 shows a distribution in brightness of a video B subsequent to the video A. As shown in FIGS. 3 and 4, since the distributions in brightness of the video A and the video B are largely changed, such a change is detected as a scene change from the video A to the video B. Alternatively, the scene change may be detected using a system provided with a frame memory by acquiring a difference between the frames on every pixel, accumulating the difference, and judging the accumulated value of a predetermined level or more.

The video conversion processor 130 converts the input video signal based on the aspect ratio of the valid area judged by the valid area judging unit 110 relative to the input video signal and scene change information detected by the scene change detector 120, and outputs the converted video signal to the video display unit 200.

For instance, a case where the input video signal representing the valid area with the aspect ratio 16:9 is displayed without conversion on the display area of the video display unit 200 will be described. In this case, when the valid area judging unit 110 judges that the valid area of the input video signal has the aspect ratio of 4:3 and the scene change detector 120 detects a scene change, the video conversion processor 130 performs horizontal expansion processing to the input video signal, converts the input video signal to a video signal representing a valid area with an aspect ratio of 16:9, and outputs the converted input video signal to the video display unit 200. On the other hand, when a scene change is not detected, the video conversion processor 130 outputs the input video signal without expansion processing. When the valid area judging unit 110 judges that the input video signal represents a valid area with an aspect ratio of 16:9, the video conversion processor 130 outputs the input video signal to the video display unit 200 without expansion processing.

Moreover, a case where the input video signal representing the valid area with the aspect ratio 4:3 is displayed after expansion processing on the display area of the video display unit 200 will be described. In this case, when the valid area judging unit 110 judges that the valid area of the input video signal has an aspect ratio of 4:3, the video conversion processor 130 subsequently performs horizontal expansion processing to the input video signal, converts the input video signal to a video signal representing a valid area with an aspect ratio of 16:9, and outputs the converted input video signal to the video display unit 200. When the valid area judging unit 110 judges that the valid area of the input video signal has an aspect ratio of 16:9 and the scene change detector 120 detects a scene change, the video conversion processor 130 outputs the input video signal representing a valid area with an aspect ratio of 16:9 to the video display unit 200 without performing expansion processing to the input video signal. In other words, when a scene change is not detected, the input video signal is output to the video display unit 200 without expansion processing.

At the moment when an aspect ratio of a valid area of the input video signal is switched, the previous processing is valid. Specifically, while the input video signal representing a valid area with an aspect ratio of 4:3 is applied with expansion processing and the converted video signal is output, when the input video signal is switched to an input video signal representing a valid area with an aspect ratio of 16:9, the video conversion processor 130 performs expansion processing to the input video signal representing the valid area with the aspect ratio of 16:9 to output the input video signal. On the other hand, while the input video signal representing the valid area with the aspect ratio of 16:9 is output without conversion processing, when the input video signal is switched to an input video signal representing a valid area with an aspect ratio of 4:3, the video conversion processor 130 outputs the input video signal representing the valid area with the aspect ratio of 4:3 without conversion processing.

The video display unit 200 conducts a control for displaying the output video signal outputted from the video conversion processor 130 on a display area. The display area is configured to have an aspect ratio of 16:9. Various display panels such as a plasma display panel (PDP), a liquid crystal panel, and an organic EL panel and various display device such as a display using various electron discharge such as an FED (field emission display) and a CRT (cathode-ray tube) are usable as the display area.

### Operation of Video Display Device

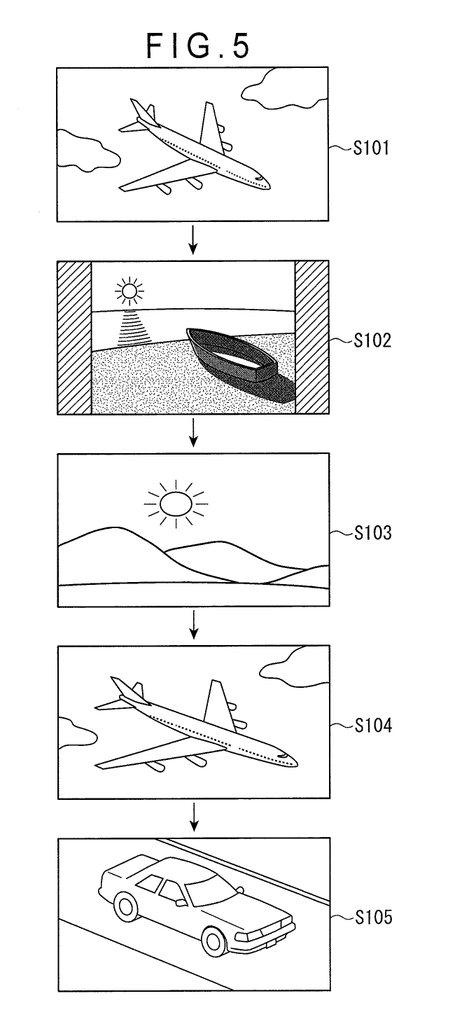

Next, an operation of the video display device will be described according to a flow of videos shown in FIG. 5.

FIG. 5 is an illustration showing a flow of the videos displayed on the video display device according to the first exemplary embodiment.

Initially, the video signal representing the valid area with the aspect ratio of 16:9 is input to the video display device in an initial state from a broadcasting station through an antenna (not shown) and the like. Herein, the initial state indicates a state where a video signal is not displayed on the video display unit of the video display device. The video display unit 130 outputs the input video signal to the video display unit 200 without any change to display a video on the display area (Scene S101). Simultaneously to this operation, the valid area judging unit 110 judges an aspect ratio of the valid area of the input video signal. Here, since the aspect ratio of the valid area is judged as 16:9 and the aspect ratio of the display area and the aspect ratio of the valid area are identical, the video conversion processor 130 does not perform expansion processing irrespective of detection results of the scene change detector 120 and the video conversion processor 130 outputs the input video signal to the video display unit 200 without any change until the aspect ratio of the valid area of the subsequent input video signal is changed.

Thus, the video signal representing the valid area with the aspect ratio of 4:3 is input to the video display device. Likewise, the video display unit 130 outputs the input video signal to the video display unit 200 without any change to display a video on the display area (Scene S102). Simultaneously to this operation, the valid area judging unit 110 judges the aspect ratio of the valid area of the input video signal. Here, the aspect ratio of the valid area is judged as 4:3. When the aspect ratio is changed, results of a scene change detected by the scene change detector 120 become valid. When a scene change is not detected, the video conversion processor 130 outputs the input video signal to the video display unit 200 without any change. When the scene change is detected, the video conversion processor 130 performs horizontal expansion processing to the input video signal after the scene change, and outputs the video signal representing the valid area with the aspect ratio converted to 16:9 to display a video on the display area (Scene S103).

The video conversion processor 130 performs expansion processing to the input video signal and outputs the converted video signal to the video display unit 200 until the aspect ratio of the valid area of the subsequent input video signal is changed.

Next, the video signal representing the valid area with the aspect ratio of 16:9 is input to the video display device. Likewise, the video display unit 130 performs expansion processing to the input video signal and outputs the converted video signal to the video display unit 200 to display a video on the display area (Scene S104). Simultaneously to this operation, the valid area judging unit 110 judges an aspect ratio of the valid area of the input video signal. Here, the aspect ratio of the valid area is judged as 16:9. When the aspect ratio is changed, results of scene change detected by the scene change detector 120 become valid. When a scene change is not detected, the video conversion processor 130 performs expansion processing to the input video signal and outputs the converted video signal to the video display unit 200. When a scene change is detected, the video display unit 130 outputs the input video signal after the scene change to the video display unit 200 without expansion processing to display a video on the display area (Scene S105).

Thus, when the aspect ratio of the valid area of the input video signal is changed, a scene change is detected and the valid area is converted synchronously with the detected scene change for display.

### Advantage(s) of First Exemplary Embodiment

The video display device according to the first exemplary embodiment as described above offers the following advantages.

(1) In the above exemplary embodiment, the valid area judging unit 110 judges a change of the aspect ratio of the valid area of the video signal inputted to the video display device, the scene change detector 120 detects a scene change when the aspect ratio is changed, and the video conversion processor 130 converts the input video signal synchronously with the scene change. With this arrangement, a series of similar scenes are displayed at the same aspect ratio while a video having a converted aspect ratio is displayed when the scenes are switched.

Accordingly, since abrupt change of the aspect ratio is avoided when a series of similar scenes are being displayed, the videos can be suitably displayed without bringing unnaturalness and annoyance to users. Moreover, since the aspect ratio is automatically switched by the video display device, an annoying operation on remote control by the users can be eliminated.

(2) When the aspect ratio of the valid area of the input video signal is 4:3, the video having the aspect ratio expanded to 16:9 is displayed on the display area of the video display unit 200, so that brightness of an entire display area is kept uniform to avoid a seizure.

(3) Further, since the video can be displayed over the entire display area by converting the aspect ratio of the valid area, a video can be displayed correspondingly to a screen size, which provides a satisfactory video display to the users.

(4) When the input video signal representing the valid area with the aspect ratio of 16:9 is expanded and displayed on the video display unit 200, the video conversion unit 130 outputs the input video signal without converting the aspect ratio of the valid area synchronously with the scene change.

Accordingly, since a video displayed with deficient information can be naturally displayed in an appropriate valid range, a suitable video display can be provided without bringing unnaturalness and annoyance to the users.

### SECOND EXEMPLARY EMBODIMENT

In a second exemplary embodiment, the same arrangement as that in the first exemplary embodiment is applied except for an operation of the video conversion processor. The video conversion processor will be described.

### Operation of Video Display Device

A video conversion processor 131 is differently operated only when the video signal representing the valid area with the aspect ratio of 16:9 is input while the input video signal representing the valid area with the aspect ratio of 4:3 is applied with expansion processing to be converted to have the valid area with the aspect ratio of 16:9 and displayed on the display area of the video display unit 200.

While the input video signal representing the valid area with the aspect ratio of 4:3 is applied with expansion processing for display, when the video signal representing the valid area with the aspect ratio of 16:9 is input, the video conversion processor 131 immediately switches the processing without detecting a scene change. Specifically, when the valid area judging unit 110 judges that the input video signal represents a valid area with an aspect ratio of 16:9, the video conversion processor 130 outputs the input video signal representing the valid area with the aspect ratio of 16:9 to the video display unit 200 without expansion processing.

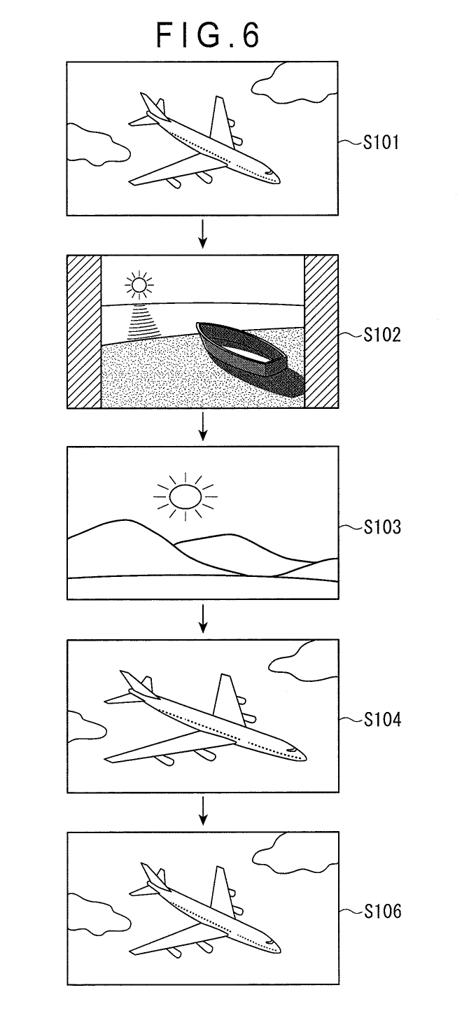

Next, specific operations will be described referring to FIG. 6.

FIG. 6 is an illustration showing a flow of the videos displayed on the video display device according to the second exemplary embodiment.

In FIG. 6, operations after Scene S104 are different from those in the first exemplary embodiment.

Scene S103 displays a video provided by expansion processing to the input signal representing the valid area with the aspect ratio of 4:3.

Subsequently, when a video signal representing a valid area with an aspect ratio of 16:9 is input, the video conversion processor 131 performs expansion processing to the input video signal and outputs the converted video signal to the video display unit 200 to display the video (Scene S104). When the valid area judging unit 110 judges that the input video signal is a video signal representing a valid area with an aspect ratio of 16:9, the video conversion processor 131 immediately outputs the input video signal representing the valid area with the aspect ratio of 16:9 to the video display unit 200 without expansion processing to display a video (Scene S106).

### Advantage(s) of Second Exemplary Embodiment

In the second exemplary embodiment, the following advantages can be obtained in addition to the advantages (1) to (3) obtained in the first exemplary embodiment.

(5) When a video signal representing a valid area with an aspect ratio of 16:9 is input while an input video signal representing a valid area with an aspect ratio of 4:3 is displayed on a display area of the video display unit 200 after expansion processing, immediately after the video signal is judged to represent a valid area with an aspect ratio of 16:9, the input video signal representing the valid area with the aspect ratio of 16:9 is displayed on the display area of the video display unit 200 without expansion processing, even during output of a series of similar scenes.

An input video signal representing a valid area with an aspect ratio of 16:9 is applied with expansion processing because the input video signal is displayed with deficient information. In the second exemplary embodiment, since the input video signal is displayed in a suitable valid area just after detecting a valid area of the input video signal, a deficient-information time becomes short and the users can obtain suitable information.

### Modifications of Exemplary Embodiment(s)

Though the invention has been described above with reference to the exemplary embodiments, the scope of the invention is not limited thereto but includes various improvements and variations in the design as long as an object of the invention can be achieved.

The above exemplary embodiments describe, for instance, a case where the video display unit 200 having the valid area with the aspect ratio of 16:9 is used for display. However, a suitable video display can also be performed by controlling conversion of an input video signal when a video display unit having a valid area with an aspect ratio of 4:3 is used for display.

Moreover, in the above exemplary embodiments, horizontal expansion processing is performed based on a detection of presence or absence of the valid area and non-image portions on left and right sides of the valid area. However, a video further including black-belt-like non-image portions on top and bottom of the video is also processable. For instance, non-image portions are displayed on top and bottom of videos such as a movie film. The valid area judging unit 110 detects a valid area and non-image portions on top and bottom of the valid area. Vertical expansion processing is performed synchronously with a scene change detected by the scene change detector 120 to switch the videos. Thus, unnaturalness and annoyance caused by an abrupt change of an aspect ratio when a series of similar scenes are displayed can be prevented.

In the above exemplary embodiments, a case where the input video signal is added with the left-and-right non-image portions is described. However, the invention is also applicable to a case where black-belt-like portions are added in the video display device. For instance, a non-image portion generation unit is further provided. The non-image portion generation unit adds non-image portions in accordance with an input video signal. The same processing as that in the above exemplary embodiments can be performed to the video signal added with the non-image portions.

In the above exemplary embodiments, the scene change detector 120 detects a scene change from videos. However, the scene change detector 120 may detect a scene change by detecting switch of audio information included in the video signal. By comprehensively judging the scene change detected from videos and the scene change detected from audio information, a highly accurate detection of a scene change is possible.

In the above exemplary embodiments, cases where the aspect ratios of the valid area are 16:9 and 4:3 are described. However, the aspect ratio of the valid area is not limited to these. The invention is applicable to a display unit having a valid area with another aspect ratio.

In addition, the functions may be constructed in the form of programs in the above description or be arranged in a hardware such as a circuit board, in an element such as an IC (integrated circuit), or in any other suitable manner. When the components are read from the program or the recording medium, operation can be facilitated and usage can be easily expanded.

The specific arrangements and methods for carrying out the invention may be modified as necessary as long as an object of the invention can be achieved.

### Advantage(s) of Exemplary Embodiments

In the above exemplary embodiment, the valid area judging unit 110 judges a change of the aspect ratio of the valid area of the video signal input to the video display device, the scene change detector 120 detects a scene change when the aspect ratio is changed, and the video conversion processor 130 converts the input video signal synchronously with the scene change. With this arrangement, a series of similar scenes are displayed at the same aspect ratio while a video having a modified aspect ratio is displayed when the scenes are switched.

Accordingly, since abrupt change of the aspect ratio is avoided when a series of similar scenes are being displayed, the videos can be suitably displayed without bringing unnaturalness and annoyance to users. Moreover, since the aspect ratio is automatically switched by the video display device, an annoying operation on remote control by the users can be eliminated.

### INDUSTRIAL APPLICABILITY

The invention is usable as a video display device, video display method, video display program and recording medium having the program recorded thereon.

1. A video display controller that processes an input video signal to display the input video signal on a display area with a predetermined aspect ratio, the video display controller comprising:
a valid area judging unit that judges an aspect ratio of a valid area represented by the input video signal;
a scene change detector that detects a scene change in the input video signal; and
a video conversion processor that converts the input video signal by an expansion processing or a non-expansion processing of the valid area in accordance with a change of the aspect ratio of the valid area in the input video signal, and displays the converted input video signal as an output video signal on the display area, wherein:
the display area has a first aspect ratio; and
the video conversion processor synchronizes at least one of the expansion processing and the non-expansion processing with the detected scene change,
when the aspect ratio of the valid area in the input video signal is changed from the first aspect ratio to a second aspect ratio smaller than the first aspect ratio, the video conversion processor outputs the input video signal as an output video signal without converting the aspect ratio of the valid area in an absence of a detection of the scene change, and the video conversion processor outputs an output video signal obtained by expanding the aspect ratio of the valid area to the first aspect ratio on detecting the scene change, and
when the aspect ratio of the valid area in the input video signal is changed from the second aspect ratio to the first aspect ratio, the video conversion processor immediately outputs the input video signal as an output video signal without converting the aspect ratio of the valid area.

2-3. (canceled)

4. A video display device comprising: the video display controller according to claim 1; and
a video display unit that displays the output video signal generated in the video display controller.

5-7. (canceled)

8. A recording medium that records a video display program functioning as the video display controller according to claim 1 in a manner readable by a computer.
